(19) United States
(12) Patent Application Publication
(10) Pub. No.: US 2009/0151702 A1
(43) Pub. Date: Jun. 18, 2009

(54) Fluid Transfer Device

(76) Inventor: Gary L. Howard, Milan, OH (US)

Correspondence Address: Douglas V Pavelko;MacMillan Sobanski & Todd, One Maritime Plaza 5th Floor, 720 Water Street, Toledo, OH, 43604, US

(21) Appl. No.: 11/887,752

(22) PCT Filed: Mar. 31, 2006
(86) PCT No.: PCT/US2006/011871

§ 371 Date: Jan. 23, 2009

Related U.S. Application Data
(60) Provisional application No. 60/669,296, filed on Apr. 7, 2005.

(51) Int. Cl. F02M 37/06

(52) U.S. Cl. 123/497; 137/565.26

(57) ABSTRACT

A device for transferring fluid for use with diesel engines includes a manifold system having at least one inlet valve, at least one outlet valve, a plurality of conduits formed therein, and an electric pump. At least one check valve is disposed between an inlet valve and an outlet valve.

### BACKGROUND OF THE INVENTION

This invention relates in general to fluid transfer systems and in particular to an improved fluid transfer device adapted for use particularly with diesel engines.

### SUMMARY OF THE INVENTION

The present invention relates to a fluid transfer device for use with diesel engines. The fluid transfer device includes a manifold system having at least one inlet valve, at least one outlet valve, a plurality of conduits formed therein, and an electric pump. At least one check valve is disposed between an inlet valve and an outlet valve.

Other aspects of this invention will become apparent to those skilled in the art from the following detailed description of the invention, when read in light of the accompanying drawings.

### BRIEF DESCRIPTION OF THE DRAWINGS

FIG. 1 is a front perspective view of a fluid transfer device.

FIG. 2 is a front perspective view of the fluid transfer device illustrated in FIG. 1, showing a manifold system.

FIG. 3 is a side perspective view of the manifold system illustrated in FIGS. 1 and 2.

FIG. 4 is a rear perspective view of the manifold system illustrated in FIGS. 1 through 3.

### DETAILED DESCRIPTION OF THE INVENTION

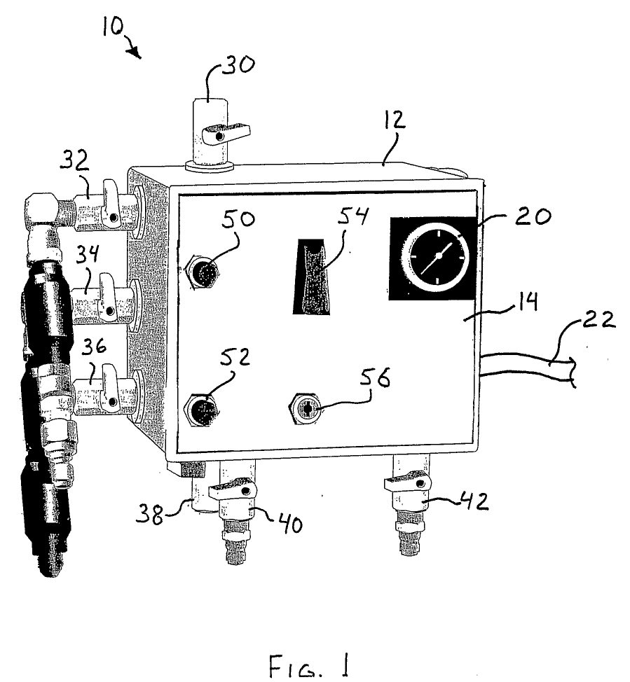

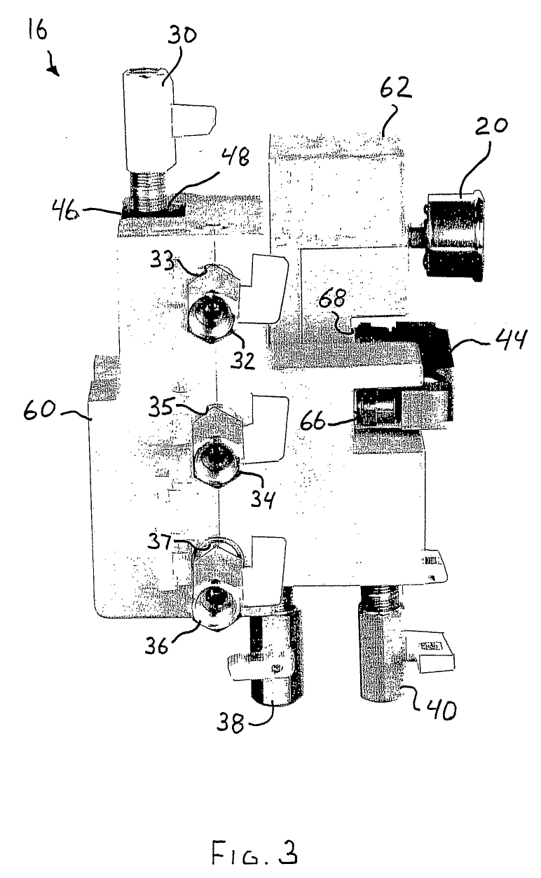

Referring now to FIGS. 1 through 4, there is illustrated a fluid transfer device, indicated generally at 10. As shown therein, the device 10 includes a housing 12, a cover 14, a fluid conduit or manifold system, indicated generally at 16, an electric pump 18, a pressure gauge 20, such as for example a liquid filled, vibration dampened pressure gauge, and a power supply cord 22. In the illustrated embodiment the electric pump 18 is a 12 volt electric pump. Alternatively, the fluid transfer device 10 can be other than illustrated if so desired. For example, the device 10 can include more than one pump 18, more than one pressure gauge 20, other sizes of electric pumps 18, and/or other kinds of, or more than one power supply cord 22, if so desired.

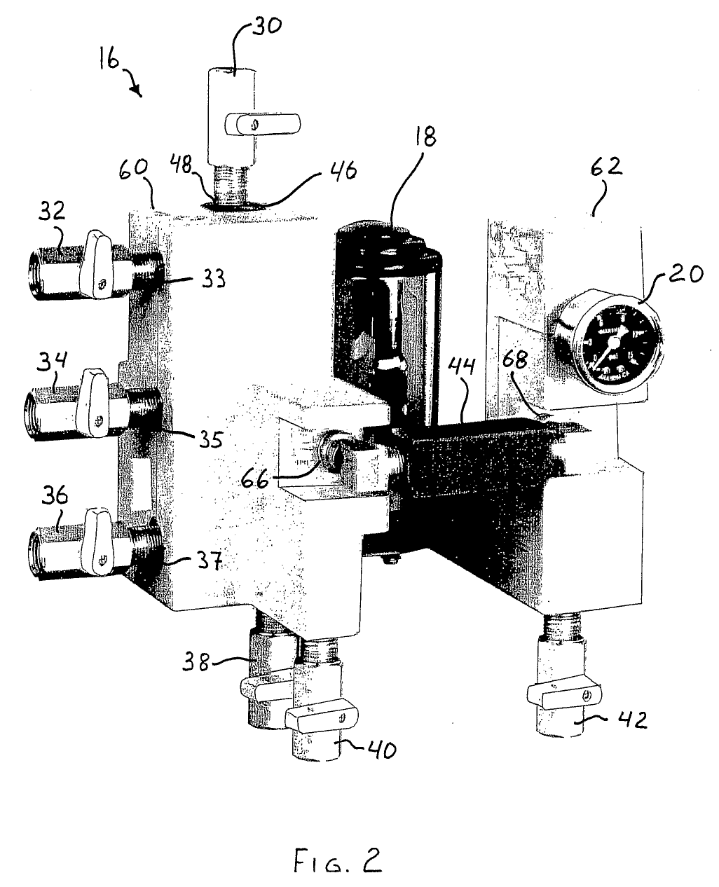

As best shown in FIGS. 2 through 4, the manifold system 16 includes a first manifold portion 60, a second manifold portion 62, a plurality of inlet valves, a plurality of outlet valves, and a plurality of check valves arranged in a predetermined manner. The check valves may be integrated into the manifold system 16 to prevent cross contamination of fluids within the system 16.

In the illustrated embodiment, the first manifold portion 60 has a plurality of conduits formed therein and includes first and second check openings 64 and 66. The second manifold portion 62 has a plurality of conduits formed therein and includes a third check opening 68. A first check valve 44 is mounted within the second opening 66. A second check valve 46 is mounted within the first opening 64 of the first manifold portion 60 and the third opening 68 of the second manifold portion 62. The second check valve 46 includes an inlet end 47 having a valve opening 48. The check valves 44 and 46 may be mounted within the openings 64, 66, and 68 by any desired means, such as for example by a threaded connection. The first and second manifold portions 60 and 62 can be other than illustrated if so desired.

In the illustrated embodiment, the first and second manifold portions 60 and 62 are formed from aluminum. Alternatively, the first and second manifold portions 60 and 62 may be formed from other suitable metals, alloys, or non-metals, if so desired. Alternatively, the fluid conduit or manifold system 16 may include a plurality of interconnected pipes such as shown for example in FIG. 5 of U.S. Provisional Application No. 60/669,296, the contents of which are herein incorporated by reference in entirety.

In the illustrated embodiment, the first manifold portion 60 includes three inlet openings 33, 35, and 37. A first inlet source or valve 30 is mounted within the check valve 46. Second, third, and fourth inlet sources or valves 32, 34, and 36, respectively, are mounted within the openings 33, 35, and 37. The inlet valves 30, 32, 34, and 36 may be mounted within the openings 48, 33, 35, and 37 by any desired means, such as for example by a threaded connection.

In the illustrated embodiment, the first manifold portion 60 includes first and second outlet openings (not shown), and the second manifold portion 62 includes a third outlet opening (not shown). First, second, and third outlet sources or valves 38, 40 and 42, respectively, are mounted within the first, second, and third outlet openings. The outlet valves 38, 40, and 42 may be mounted within the outlet openings by any desired means, such as for example by a threaded connection.

In the illustrated embodiment, the first inlet valve 30 is operatively connected to a first fluid supply, such as for example the engine fuel supply. The second inlet valve 32 is operatively connected to a second fluid supply, such as for example, a supply of reefer engine oil, hydraulic oil, oil from a vehicle generator system, or oil from a marine generator system crankcase. The second inlet valve 32 may also be used to transfer fuel from another source, or may be plumbed to the bilge section of a marine vessel for emergency water transfer and removal. The third inlet valve 34 is operatively connected to a third fluid supply, such as for example, a supply of automatic transmission oil. The fourth inlet valve 36 is operatively connected to a fourth fluid supply, such as for example, a supply of engine oil.

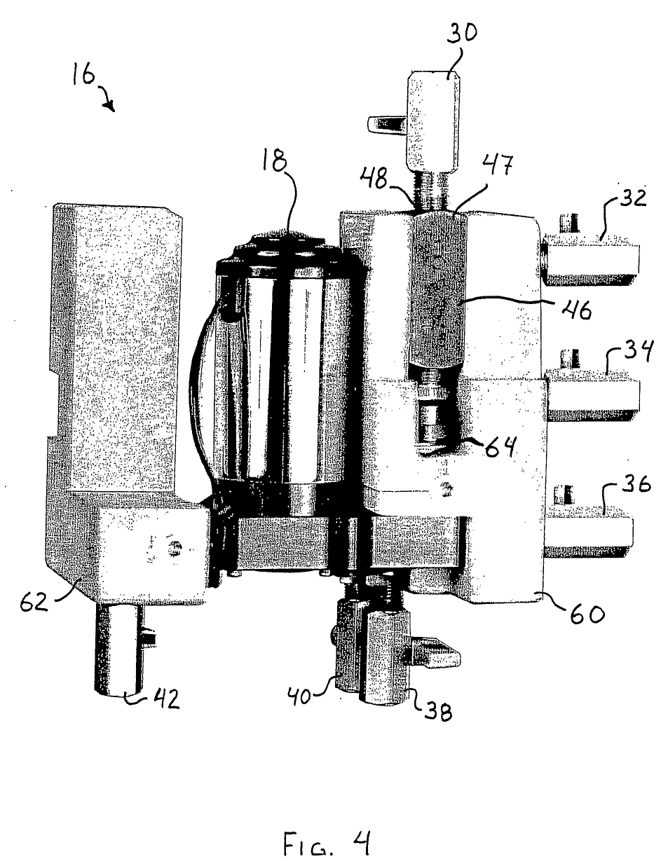

In the illustrated embodiment, the first outlet valve 38 is operatively connected to the engine fuel supply, the second outlet valve 40 is operatively connected to the second and third fluid supplies, and the third outlet valve 42 is operatively connected to another fluid or oil-receiving source. The first check valve 44 is operative to prevent fuel from flowing to an oil-receiving source, such as an oil pan. The second check valve 46 is operative to prevent oil from flowing to the engine fuel system. Alternatively, the particular configuration of the manifold system 16 can be other than illustrated if so desired, and can include any number of desired inlet valves, outlet valves and/or check valves which are arranged or configured in any desired manner to accomplish one or more of the features and functions to be discussed below. As best shown in the embodiment illustrated in FIG. 4, the pump 18 is mounted between the first manifold portion 60 and the second manifold portion 62.

As best shown in FIG. 1, the illustrated embodiment of the fluid transfer device 10 further includes two indicator lights 50 and 52, an actuation switch assembly 54 (ON-OFF switch) operatively connected to the pump 18, and a key lock 56 operatively connected to the actuation switch assembly 54. The indicator lights indicate, for example, the presence in the device 10 of power from a primary and/or a secondary power source. Alternatively, the construction of the fluid transfer device 10 can be other than illustrated if so desired.

To operate the illustrated embodiment of the fluid transfer device 10, the power supply cord 22 is connected to a suitable power source and selected inlet valves and outlet valves are moved from a normally closed position to an open position to provide a fluid path. Next, the key lock 56 is turned from a normally OFF position to an ON position. Following this, the actuation switch assembly 54 is moved from a normally OFF position to an ON position, actuating the electric pump 18. Fluid then flows through the conduits of the manifold system 16 of the device 10 along a path determined by the particular inlet valves 32, 34, 36, and 38, and outlet valves 38, 40, and 42 that were opened.

The illustrated embodiment of the fluid transfer device 10 is for transferring oil, transferring fuel, and/or transferring water. The illustrated fluid transfer device 10 is particularly useful for use with diesel engines, such as for example, in military, truck, boat, recreational vehicle, and construction equipment applications. Changing the oil in such a diesel vehicle or engine can be accomplished in a matter of minutes in a vehicle or engine using the illustrated fluid transfer device 10, for example by moving the used oil from the crankcase and transferring the used oil to the vehicles' fuel tank(s) or to an outside oil recovery tank. Oil, such as for example engine, transmission, and hydraulic oil, can be changed anytime, anywhere, such as for example in construction equipment in the field. Accordingly, wait time at a service garage can be eliminated, and the scheduling of maintenance service can be significantly reduced or eliminated. Labor costs can also be reduced by reducing the need for service trucks on a job site.

When transferred to a vehicle fuel tank, the used oil is blended with virgin diesel fuel and burned as fuel. The blending of the used oil in the fuel system allows the fuel to burn at a higher BTU resulting in a cleaner burn with fewer toxins in emissions. The properties of the oil/fuel mixture provide additional lubrication to fuel system components, such as injectors and fuel pumps, thereby extending the life of such components. Oil filter changes may be reduced by about 75 percent due to more frequent oil changes.

The illustrated device 10 provides a means of transferring used oil to the fuel system without exposing the oil to the environment or to the operator, and without the need or expense of waste oil disposal. Used engine oil becomes an easily accessible fuel source and the additional volume in the fuel system reduces fuel costs. The operator can experience a fuel savings of one gallon of fuel for every gallon of waste oil purged from the oil system. The convenience of the illustrated device 10 can result in cost savings by allowing for more frequent oil changes. Also, using cleaner oil extends engine life by, for example, reducing wear on bearings and piston rings. In addition, the illustrated device 10 provides a means of drawing both a fuel and oil sample through specified valves, such as for example the valves 38, 40, and 42. The illustrated device 10 also provides a source of fuel for priming systems that have been voided without the need of an external fuel source.

The illustrated device 10 is convenient and can also be used to transfer fuel between vehicles or tanks, to trailer reefer units, or through the device 10 from another vehicle to a third vehicle. The device 10 may also be used to fill fuel filters, such as through the second outlet valve 40, and to take oil samples, such as through the third outlet valve 42.

The illustrated device 10 may also be used for the transfer of water, for example in remote areas. Water can be drawn from source, such as streams or rivers, and used to fill containers, such as radiators and water cans. Such water may also provide a water source for showering. This feature can also be used in marine applications as an additional bilge pump in an emergency situation. Depending upon the particular size of the manifold system 16, the valves and other components of the device 10, the device 10 can pump or transfer within the range of from about 150 gallons to about 300 gallons of fluid, such as water, per hour.

The oil transfer feature of the device 10 may also be used with twin diesel engines in marine applications. Through a series of valves of the device 10, such as for example, the valves 32 and 36, oil is released from the crankcase, drawn into the device 10, and then pumped through, for example, the valve 38 to the fuel system return lines and into the fuel tanks. Suitably arranged check valves within the device 10, such as for example, the first check valve 44, prevent the oil from passing to the engine before blending with the diesel in the fuel tanks and prevent fuel from passing to the oil system. Different configurations of valves in the device 10 can provide a system to either take on fuel or transfer fuel or water (bilge) without compromising the fuel and oil systems.

Alternatively, the construction of the fluid transfer device 10 can be other than illustrated if so desired. For example, the number, location, arrangement and/or operation of one or more of the components of the device 10 can be other than illustrated if so desired. Also, while the device 10 has been illustrated and described and being a “manually” operated device, it will be appreciated that the device could be partly or fully automatically operated and/or remotely operated if so desired.

The principle and mode of operation of this invention has been described in one or more of its various embodiments. However, it should be noted that this invention may be practiced otherwise than as specifically illustrated and described without departing from its scope.

What is claimed is:

1. A fluid transfer device for use with diesel engines, said fluid transfer device comprising:
a manifold system having at least one inlet valve, at least one outlet valve, and a plurality of conduits formed therein;
an electric pump; and
at least one check valve disposed between an inlet valve and an outlet valve.

2. The fluid transfer device according to claim 1, further including a housing having an open end and a closed end, said manifold system being disposed therein.

3. The fluid transfer device according to claim 2, further including a cover for closing the open end of said housing.

4. The fluid transfer device according to claim 2, wherein said housing further includes at least one indicator light.

5. The fluid transfer device according to claim 2, wherein said housing further includes an actuation switch.

6. The fluid transfer device according to claim 2, wherein said housing further includes a key lock operatively connected to an actuation switch.

7. The fluid transfer device according to claim 2, wherein said housing further includes a pressure gauge mounted thereto, said pressure gauge for measuring fluid pressure within at least one of said plurality of conduits of said manifold system.

8. The fluid transfer device according to claim 7, wherein said pressure gauge is a liquid filled, vibration dampened pressure guage.

9. The fluid transfer device according to claim 1, further including a power cord for supplying power to said electric pump.

10. The fluid transfer device according to claim 1, wherein said pump is a 12-volt electric pump.

11. The fluid transfer device according to claim 1, wherein said pump can pump within the range of from about 150 gallons to about 300 gallons of fluid per hour.

12. The fluid transfer device according to claim 1, wherein said manifold system includes a first manifold portion and a second manifold portion, said first manifold portion in fluid communication with said second manifold portion.

13. The fluid transfer device according to claim 12, wherein said first manifold portion includes a plurality of conduits, said conduits defining a fluid flow path.

14. The fluid transfer device according to claim 13, wherein said first manifold portion includes a plurality of inlet openings in fluid communication with said conduits.

15. The fluid transfer device according to claim 14, wherein said first manifold portion includes three inlet openings.

16. The fluid transfer device according to claim 14, further including a plurality of inlet valves disposed within each of said inlet openings.

17. The fluid transfer device according to claim 13, wherein said first manifold portion includes a plurality of outlet openings in fluid communication with said conduits.

18. The fluid transfer device according to claim 17, wherein said first manifold portion includes two outlet openings.

19. The fluid transfer device according to claim 17, further including a plurality of outlet valves disposed within each of said outlet openings.

20. The fluid transfer device according to claim 13, further including at least one check valve disposed in said fluid flow path.

21. The fluid transfer device according to claim 13, further including at least one check valve disposed between said first manifold portion and said second manifold portion.

22. The fluid transfer device according to claim 12, wherein said second manifold portion includes a plurality of conduits, said conduits defining a fluid flow path.

23. The fluid transfer device according to claim 22, wherein said second manifold portion includes a plurality of inlet openings in fluid communication with said conduits.

24. The fluid transfer device according to claim 22, wherein said second manifold portion is fluidly connected to said first manifold portion.

25. The fluid transfer device according to claim 22, wherein said second manifold portion includes at least one outlet opening in fluid communication with said conduits.

26. The fluid transfer device according to claim 22, wherein said second manifold portion includes a plurality of outlet openings in fluid communication with said conduits.

27. The fluid transfer device according to claim 25, further including at least one outlet valve disposed within said at least one outlet opening.

28. The fluid transfer device according to claim 22, further including at least one check valve disposed in said fluid flow path.
